(19) United States
(12) Patent Application Publication
(10) Pub. No.: US 2007/0143201 A1
(43) Pub. Date: Jun. 21, 2007

(54) Systems and methods for selling vehicle repossession rights

(76) Inventors: Daniel R. Swanson SR., Midlothian, VA (US); Ryan B. Bell, Plano, TX (US); Mark D. Matz, Allen, TX (US); Steven R. Thibodeau, Carrollton, TX (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/300,514

(22) Filed: Dec. 15, 2005

(51) Int. Cl. G06Q 40/00

(52) U.S. Cl. 705/37

(57) ABSTRACT

Systems and methods provide online auctions or sales of vehicle repossession rights wherein the winning bid or buyer receives the right to repossess a vehicle. Using an Internet website maintained by a server, a user may view repossessed property, such as a vehicle, place a bid, or purchase the right to repossess the vehicle. The original vehicle owner's financing company then forwards legal title to the buyer. Furthermore, the buyer may transfer payment electronically to the financing company.

### TECHNICAL FIELD

Embodiments consistent with the present invention provide systems and methods for selling vehicle repossession rights. In particular, embodiments consistent with the present invention may use online auctions or sales of vehicle repossession rights wherein a buyer receives the right to repossess a vehicle.

### BACKGROUND

Financing companies are often faced with the need to repossess a vehicle when a borrower fails to make a payment towards a loan that financed the vehicle's purchase. Typically, the financing company will attempt to contact the borrower several times when a loan becomes past due and may send written reminders of the amount due. However, once the loan is in default for a period of time, the financing company may proceed with repossession of the vehicle.

In order to repossess the vehicle, the financing company typically hires or employs a repossession agent to retrieve the vehicle from the borrower. Once the vehicle has been returned to the financing company, the vehicle is sold at auction and the proceeds of the sale are applied to the outstanding loan. However, before the vehicle can be auctioned, the financing company may also incur additional costs to ready the vehicle for auctioning. For example, the vehicle may need to be cleaned so that it is presentable at the auction. Furthermore, the vehicle must be transported to the auction. Further still, the auction itself constitutes an additional cost.

Once the vehicle reaches the auction, the vehicle will be sold, the vehicle's title will be transferred to the buyer, and the proceeds from the sale will be applied to the outstanding loan balance. However, the amount obtained for the vehicle at the auction is often dramatically less than the outstanding loan balance. As discussed, the recovered amount is also reduced by a variety of other costs. Accordingly, the recovered amount typically usually not only fails to cover the amount owed, but the costs of repossessing and auctioning the vehicle further reduce the recovered amount.

There is therefore a need for systems and methods to sell or auction a vehicle in a manner such that the recovery is maximized instead of being reduced due to the costs associated with repossessing and auctioning the vehicle.

### SUMMARY

Consistent with an embodiment of the present invention, a method is provided for auctioning a right to repossess a vehicle. The method comprises receiving over a network, from a plurality of terminals, one or more bids on the right to repossess the vehicle; determining, by a server communicating with the plurality of terminals over the network, a winning bidder; electronically receiving payment from the winning bidder; and transmitting, by the server, a notification of the right to repossess the vehicle to the winning bidder.

Consistent with another embodiment of the present invention, a system is provided for auctioning a right to repossess a vehicle. The system comprises means for receiving, over a network, one or more bids on the right to repossess the vehicle; means for determining a winning bidder; means for receiving payment from the winning bidder; and means for transmitting a notification of the right to repossess the vehicle to the winning bidder.

Consistent with yet another embodiment of the present invention, a system is provided for selling a right to repossess a vehicle. The system comprise a terminal; and a server coupled to a network, wherein the server determines a purchaser of the right to repossess a vehicle using the terminal and transmits a notification of the right to repossess the vehicle to the terminal over the network.

Consistent with still yet another embodiment of the present invention, a method is provided for paying a debt using an auctioned-off right of repossession. The method comprises receiving over a network, from a plurality of terminals, one or more bids on the a right to repossess a vehicle; determining, by a server communicating with the plurality of terminals over the network, a winning bidder; electronically receiving payment from the winning bidder; and electronically applying the payment to an account.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention. In the drawings:

FIG. 1 is a diagram of an exemplary system for selling or auctioning vehicle repossession rights, consistent with an embodiment of the present invention;

FIG. 2 is a flow chart of an exemplary method for selling the right to repossess a vehicle, consistent with an embodiment of the present invention; and

FIG. 3 is a flow chart of an exemplary method for auctioning the right to repossess a vehicle, consistent with an embodiment of the present invention.

### DESCRIPTION OF THE EMBODIMENTS

Embodiments consistent with the present invention provide systems and methods for selling repossession rights. In particular, embodiments consistent with the present invention provide online auctions or sales of property repossession rights wherein the winning bid or buyer receives the right to repossess the property. In one embodiment, using an Internet website, a user may view repossessed property, such as a vehicle, place a bid on the right to repossess the vehicle, or purchase the right to repossess the vehicle. Once the right to repossess the vehicle is sold and payment is received by a financing company holding title to the vehicle as collateral for a loan, the financing company forwards the title to the buyer. For example, the financing company will provide an individual that purchases a right to repossess a vehicle with the title and the individual would need to obtain an agent to carry out the repossession. As a further example, a dealership that purchases the right to repossess a vehicle may use an agent to repossess the vehicle or could sell the right to repossess the vehicle to another party.

In embodiments consistent with implementations of the present invention, users of the website may be individuals or dealerships that bid on or purchase a right to repossess a vehicle. For example, a dealership may use the website to select vehicles that fit in with their business plan, brand, or target demographic. Users may access the website via a desktop computer or handheld device, such as a PDA or cell phone, for example. In one implementation, data describing vehicles that are available for auction or sale may be maintained in a central database of a remote system that are accessible via a network. For example, the remote system may maintain data concerning vehicles based on a geographical region or state where the property is located and additional remote systems may maintain data concern vehicles from another geographical region or state.

In one implementation of the present invention, vehicles may be listed on the website once a payment is past due or may be listed earlier so that bidders and/or purchasers have the opportunity to review actual inventory or potential inventory. For example, once a payment is past its due date, a borrower that is responsible for a loan used to purchase the vehicle is typically given anywhere from three to six months to pay before the vehicle is subject to being repossessed. Accordingly, bids for the right to repossess a vehicle could begin a specified number of days before the date the vehicle may be repossessed. Vehicles may be posted on the website anywhere from between thirty to sixty days, for example, in advance of a final loan payment due date (or date the vehicle may be repossessed). While the vehicle is not available for sale or auction at the time of the initial listing, users may be provided with some information concerning those vehicles that may become available at a later date. Such information made available may include, but is not limited to, make of vehicle, model of vehicle, color of vehicle, etc.

In other embodiments, the website may reveal data about vehicles based on “date triggers.” A “date trigger” may correspond to a particular event. As an example, once a payment for a particular vehicle is a month late, the make and model of the vehicle may become publicly listed on the website as a vehicle that may be available for auction once the remainder of the time period for making payment expires. At a later data trigger, such as when a month or less remains before the date of repossession, the website may display the rest of the details describing the vehicle, such as its year and options. As such, listing information in advance may provide dealerships or individuals with the ability to plan possible purchases based on expected auctions.

In one implementation of the present invention, auctions may open for bids when a month remains before the vehicle is subject to being repossessed by the financing company. Auctions may be closed on a date that a vehicle is due to be repossessed. Alternatively, in other implementations of the present invention, a conditional close date may be set for an auction. For example, the system may schedule an auction to close five business days after a final date to make payment. In other embodiments, auctions may be extended based on the time of the year or to take into account holidays.

Embodiments of the present invention provide the winning bidder, or an outright purchaser, the right to repossess the vehicle and the title of the vehicle. Furthermore, the financing company may apply proceeds of the auction or sale to the outstanding loan balance, and then may bill the original owner for any deficiency. In some implementations, payment from the winning bidder or purchaser can be made by electronic funds transfer. In other implementations, the financing company may instead send a check for an amount that is owed to original owner or could electronically deposit the funds in an account designated by the original owner. Still further, in other implementations, proceeds from the auction or sale may also be applied by the financing company to credit card debt of the original vehicle owner, a savings account may be established for the original vehicle owner, or the financing company may send an annuity check over the course of a set time period until the loan proceeds are distributed.

Reference will now be made to exemplary embodiments of the invention, examples of which are illustrated in the accompanying drawings. Wherever possible, the same reference numbers will be used throughout the drawings to refer to the same or like parts.

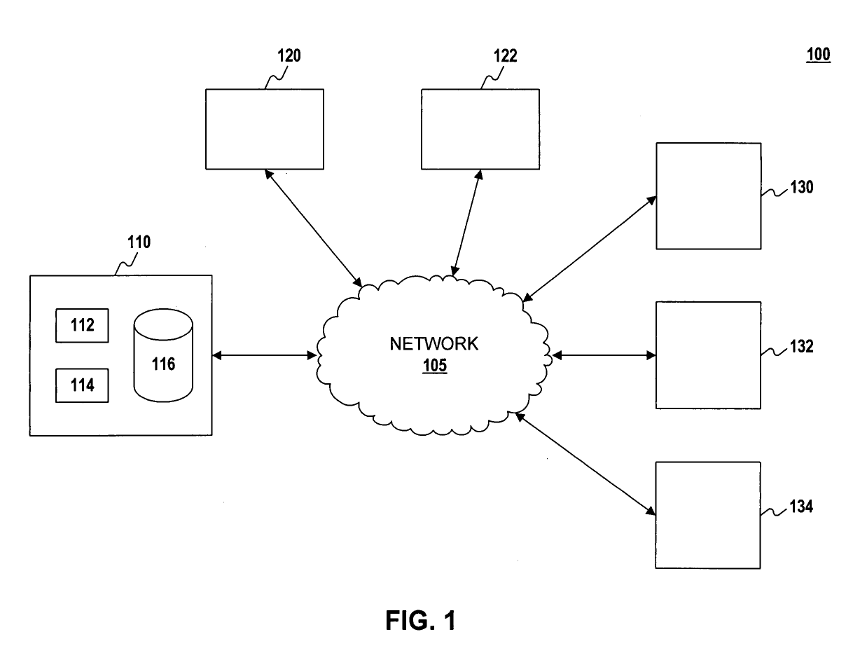

FIG. 1 is a diagram of an exemplary system 100 for auctioning or selling a right to repossess a vehicle, consistent with an embodiment of the present invention. System 100 includes a server 110, having a CPU 112, a memory 114, and a database 116. Server 110 may be operated by a financing company that provides vehicle financing services, and is connected to a network 105. Software in memory 114 preferably implements one or more software programs for auctioning or selling a right to repossess a vehicle to users located at terminals 130-134. For example, memory 114 may store software modules (not shown) for executing instructions to obtain data describing vehicles from database 116 and/or external servers 130-134. Database 116 may store data pertaining to vehicles for which the financing company has provided loans. Accordingly, server 110 may retrieve data from database 116 for use in preparing a web page that is accessible over network 105 via any one of terminals 130-134.

Network 105 provides communications between the various components in system 100, such as server 110, external servers 120-122, and terminals 130-134. Network 105 may be a shared, public, or private network and may encompass a wide or local area. Furthermore, network 105 may be implemented through any suitable combination of wired and/or wireless communication networks. By way of example, network 105 may be implemented through a wide area network (WAN), local area network (LAN), an intranet, or the Internet.

External servers 120-122 may store data pertaining to vehicles that are available for auction or sale. For example, external servers 120-122 may store data concerning vehicles based on a region or state where the property is located. Further, external servers 120-122 may exchange data to and from server 110 over network 105 to server 110.

Terminals 130-134 allow a user to send and/or receive information to and from server 110. Terminals 130-134 may be any type of appropriate device for communicating with server 110 over network 105. For example, terminals 130-134 may be a PDA running a program for communicating with server 105, a cellular phone, any appropriate handheld device, such as a Blackberry, or a desktop computer. Furthermore, a user may operate a web browser or similar software running on one of terminals 130-134 to access a webpage listing vehicles that are available for sale or auction. In embodiments consistent with the present invention, a user at one of terminals 130-134 may place bids or purchase the right to repossess a vehicle.

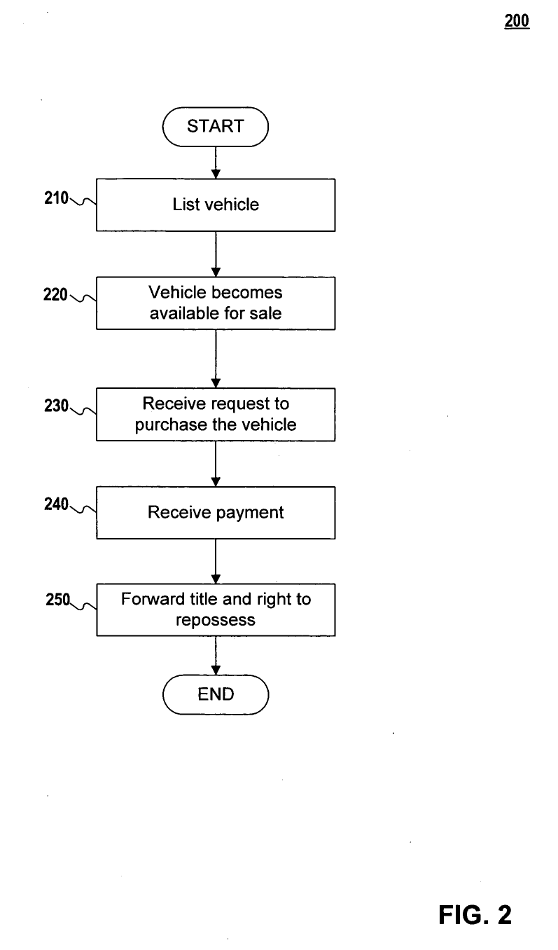

FIG. 2 is a flow chart 200 of an exemplary method for selling the right to repossess a vehicle, consistent with an embodiment of the present invention. As shown in FIG. 2, server 110, for example, may list a vehicle that will be subject to repossession. Subsequently, the vehicle becomes available for sale on a data determined by server 110. Once the vehicle becomes available for sale, payment is received from a buyer and a financing company transfers the title and right to repossess to the buyer.

In step 210, server 110, for example, may list a vehicle on a website. At the time of the vehicle's initial listing, information describing the vehicle may be limited. The website may list additional data based on date triggers as the final due date for the owner to submit a loan payment approaches. For example, once a payment for a particular vehicle is a month late, the make and model of the vehicle may become publicly available on the website. Furthermore, the vehicle may become available for sale once the remainder of the time period for making payment expires. When a month or less remains before the date of repossession, the website may display the rest of the details describing the vehicle, such as year and options.

In step 220, server 110 determines that the vehicle is available for sale. The date a vehicle becomes available for sale may correspond to a time period set by the financing company. For example, the financing company, while complying with all applicable laws, may have a policy or an agreement with borrowers that once a due date for a loan payment is missed, if payment is not made within ninety days, the financing company may proceed with repossession of the vehicle.

In step 230, a user may decide to purchase the vehicle. The user may log onto a website provided by server 110 and may supply a user name and password using one of terminals 130-134, for example. Once authorized, a user may access an account that maintains a list of vehicles that may be based on criteria that the user has identified as being of interest. For example, the account may list vehicles that may not be available for sale or auction, but that the user has identified as of interest to the user once the vehicle or repossession rights becomes available. In other implementations, an e-mail notification may be sent by server 110 to a user at one of terminals 130-134 once a vehicle is open for sale or when additional information about the vehicle becomes available.

In step 240, the financing company receives payment from the buyer. Payment may be received in several ways. For example, the buyer may submit payment by navigating to a portion of the website provided by server 110 whereby the buyer may supply bank account information in order to facilitate an electronic funds transfer. Furthermore, the buyer may mail a check or may receive a loan from the financing company in the purchase amount.

Once payment is received by the financing company, the financing company may apply proceeds of the sale to the outstanding loan balance, and then bill the original owner for any deficiency. The proceeds may be distributed in a variety of ways, such as via electronic funds transfer. In other implementations, the financing company may send a check for an amount that is owed to a borrower that agreed to a loan to purchase the vehicle, or could electronically deposit the funds to an account. Still in further implementations, proceeds from the sale may also be applied by the financing company to credit card debt of the borrower, or a savings account may be established for the borrower, or the financing company may send an annuity check over the course of a set time period until the loan proceeds are distributed to the borrower. Once the proceeds have been applied, server 110 may transmit a notification, such as an e-mail, to the buyer indicating that the sale has been completed and/or a notification to the borrower that the vehicle has been sold and providing an accounting of the funds raised by the sale of the vehicle.

Next, in step 250, the financing company forwards title and the right to repossess the vehicle to the buyer. Accordingly, the buyer obtains the right to repossess the vehicle and is provided title of the vehicle from the financing company. Server 110 may send, for example, an e-mail notification to the buyer indicating that the title is on its way.

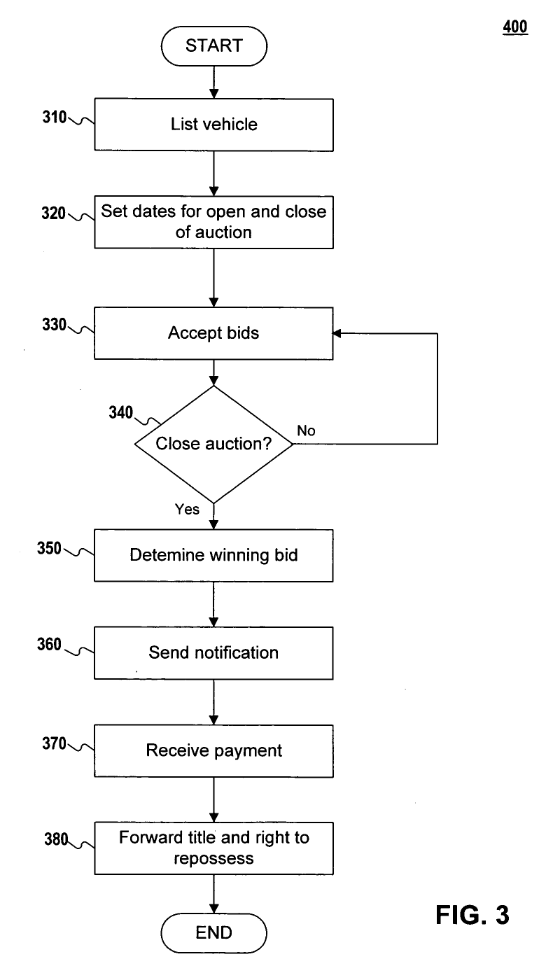

FIG. 3 is a flow chart 300 of an exemplary method for auctioning the right to repossess a vehicle, consistent with an embodiment of the present invention. As shown in FIG. 3, server 110, for example, may list a vehicle that will be subject to repossession. Subsequently, server 110 may set an open and close date for an auction, and accept bids. Once an auction closes, server 110 may send a winning bidder a notification. Once the financing company receives payment from the winning bidder, the title and the right to repossess may be provided to the winning bidder.

In step 310, server 110 lists a vehicle on a website. At the time of the vehicle's initial listing, information describing the vehicle may be limited, however, the website may list additional data based on date triggers as the final due date for the owner to submit a loan payment approaches. For example, once a payment for a particular vehicle is a month late, the make and model of the vehicle may become publicly available on the website. In one implementation, when a month or less remains before the date of repossession, the website may display the rest of the details describing the vehicle, such as year and options.

In step 320, server 110 sets an open and close date for the auction. The open date indicates when bids (e.g., date and time) will be accepted for the vehicle. The close date indicates an end date (and time, etc.) when no further bids will be accepted. In one implementation, the open date of the auction may be set as a period of days after a loan payment was due from the owner of the vehicle. For example, the loan agreement or policy of the financing company may specify that a vehicle is subject to being repossessed a period of days, such as ninety days or six months, after a due date is missed for a loan payment. In addition, consistent with implementations of the present invention, the close date of the auction may take into account the time of year, weekends, and holidays in order to set an appropriate time period for the auction.

In step 320, server 110 may accept bids from users at one of terminals 130-134 when the open date is reached. Users of terminals 130-134 may log onto the website using a password and user name, for example, for identification purposes, and place bids. After being authorized, users may view vehicles that are available for bid, and bids may be displayed on graphical user interface (GUI) of any one of terminals 130-134. In other implementations, server 110 may maintain an account in database 116 specific to a particular user. An account may list vehicles that a user has identified as of interest to the user once the vehicle becomes available for bid. In one implementation, an e-mail notification may be sent from server 110 to a user at one of terminals 130-134 once a vehicle is open for bid. Users at terminals 130-134 may place bids using threshold amounts consistent with typical auction procedures, such as setting a highest amount a bidder is willing to spend.

In one embodiment consistent with the present invention, bids may be accepted from users once a loan payment becomes past due. Auctions may open for bids, for example, when a month remains before the vehicle is subject to being repossessed by the financing company. Auctions may be closed on a date that a vehicle becomes subject to repossession. Alternatively, in other embodiments, a conditional close date may be set for an auction. For example, an auction may be scheduled to close five business days after a final date to make payment. In yet other embodiments, auctions may be extended based on time of the year or holidays to vary the close date.

In step 340, server 110 determines whether it is time to close the auction. If is not time to close the auction, the process returns to step 330 and server 110 continues to accept bids. If it is time to close, the auction, the process proceeds to step 350.

In step 350, server 110 determines the winning bidder. In exemplary embodiments, the highest bid is the winning bid. In alternative embodiments, however, the winning bid may be based upon other factors. Next, in step 260, server 110 sends a notification to the winning bidder. The notification may be sent via e-mail, over the telephone, via mail, etc., consistent with implementations of the present invention. In one embodiment, the winning bidder may receive a notification when the bidder logs onto the website. For example, an icon or message may appear on the website linking the bidder to instructions for providing payment and receiving title to the vehicle.

In step 370, the financing company receives payment from the winning bidder. Payment may be received from the winning bidder in several ways. For example, the winning bidder may submit payment by navigating to a portion of the website using one of terminals 1301-134 so that the winning bidder may supply bank account information to facilitate an electronic funds transfer. In other embodiments, the winning bidder may mail a check or may receive a loan from the financing company in the amount of the winning bid.

Once payment is received by the financing company, the financing company may apply proceeds of the auction or sale to the outstanding loan balance, and then bill a borrower that agreed to a loan to purchase the vehicle for any deficiency. The proceeds may be distributed via electronic funds transfer. Furthermore, the financing company may send a check for an amount that is owed to the borrower or could electronically deposit the funds to an account. Proceeds from the auction or sale may also be applied by the financing company to credit card debt of the borrower, a savings account may be established for the original vehicle owner, or the financing company may send an annuity check over the course of a set time period until the loan proceeds are distributed. to the borrower.

In step 380, the financing company forwards title and the right to repossess the vehicle to the winning bidder. The winning bidder obtains the right to repossess the vehicle and is provided title of the vehicle from the financing company. Server 110 may send, for example, an e-mail notification to the winning bidder indicating that the title is on its way.

Accordingly, systems and methods consistent with the present invention provide online auctions or sales of vehicle repossession rights wherein the winning bidder, or outright purchaser, receives the right to repossess the property. As discussed in the examples shown in FIG. 2 and FIG. 3, the property may be a vehicle, however, one of ordinary skill in the art will recognize that the present invention may apply to other types of property as well. Furthermore, although the above description describes the use of an Internet website, the example is not intended to be limiting, and rights to repossess property may be sold or auctioned using other means, such as by telephone, for example.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Computer programs based on the written description and methods of this invention are within the skill of an experienced developer. The various programs or program modules can be created using any of the techniques known to one skilled in the art or can be designed in connection with existing software. For example, program sections or program modules can be designed in or by means of Java, C++, HTML, XML, or HTML with included Java applets. One or more of such software sections or modules can be integrated into a computer system or existing e-mail or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

What is claimed is:

1. A method for auctioning a right to repossess a vehicle, the method comprising:
receiving over a network, from a plurality of terminals, one or more bids on the right to repossess the vehicle;
determining, by a server communicating with the plurality of terminals over the network, a winning bidder;
electronically receiving payment from the winning bidder; and
transmitting, by the server, a notification of the right to repossess the vehicle to the winning bidder.

2. The method of claim 1, wherein the vehicle is auctioned on a website and a financing company holds title to the vehicle.

3. The method of claim 1, wherein the server sets an open date of the auction and a close date of the auction.

4. The method of claim 1, wherein the notification is transmitted to a terminal of the winning bidder.

5. The method of claim 1, further comprising:
receiving payment from the winning bidder via electronic funds transfer.

6. The method of claim 5, wherein a financing company holding title to the vehicle transfers the title to the winning bidder once the payment is received.

7. The method of claim 3, wherein the open date of the auction is determined based on when the vehicle is subject to repossession.

8. A system for auctioning a right to repossess a vehicle, the system comprising:
means for receiving, over a network, one or more bids on the right to repossess the vehicle;
means for determining a winning bidder;
means for receiving payment from the winning bidder; and
means for transmitting a notification of the right to repossess the vehicle to the winning bidder.

9. The system of claim 8, wherein the vehicle is auctioned on a website and a financing company holds title to the vehicle.

10. The system of claim 8, wherein an open date of the auction and a close date of the auction are set.

11. The system of claim 8, wherein the notification is transmitted to a terminal of the winning bidder.

12. The system of claim 8, further comprising:
means for receiving payment from the winning bidder via electronic funds transfer.

13. The system of claim 12, wherein a financing company holding title to the vehicle transfers the title to the winning bidder once the payment is received.

14. The method of claim 10, wherein the open date of the auction is determined based on when the vehicle is subject to repossession.

15. A system for selling a right to repossess a vehicle, comprising:
a terminal; and
a server coupled to a network, wherein the server determines a purchaser of the right to repossess a vehicle using the terminal and transmits a notification of the right to repossess the vehicle to the terminal over the network.

16. The system of claim 15, wherein the right to repossess the vehicle is made available for sale on a website.

17. The system of claim 15, wherein the right to repossess the vehicle is auctioned on a website.

18. The system of claim 15, wherein the server receives a notification of an electronic funds transfer providing payment for the right to repossess the vehicle.

19. The system of claim 18, wherein the server credits an account when the payment is received.

20. A method for paying a debt using an auctioned-off right of repossession, the method comprising:
receiving over a network, from a plurality of terminals, one or more bids on the a right to repossess a vehicle;
determining, by a server communicating with the plurality of terminals over the network, a winning bidder;
electronically receiving payment from the winning bidder; and
electronically applying the payment to an account.

21. The method of claim 20, wherein the account belongs to a borrower that defaulted on a loan financing the purchase of the vehicle, and the account reflects a balance of the loan.

22. The method of claim 20, wherein the account is a credit card account that belongs to a borrower that defaulted on a loan financing the purchase of the vehicle.
